(19) United States
(12) Patent Application Publication
(10) Pub. No.: US 2002/0022126 A1
(43) Pub. Date: Feb. 21, 2002

(54) Textile adhesive tape

(76) Inventor: Christoph Lodde, Dortmund (DE)

Correspondence Address: JOHN S. PRATT, KILPATRICK STOCKTON LLP, 1100 PEACHTREE, SUITE 2800, ATLANTA, GA, 30309, US

(21) Appl. No.: 09/755,884

(22) Filed: Apr. 30, 2001

(30) Foreign Application Priority Data
Jan. 5, 2000 (DE) 200 00 130.2

(51) Int. Cl. B32B 15/04; B32B 5/02; B32B 27/04; B32B 27/12; D04H 13/00; B32B 7/12

(52) U.S. Cl. 428/343; 442/327; 442/402; 442/149; 442/408; 428/355 R; 428/356; 428/355 AC

(57) ABSTRACT

Textile adhesive tape consisting of an adhesive tape support from a textile, mechanically reinforced nonwoven material with adhesive coating on at least one side. The nonwoven material has a basis weight of less than or equal to 50 g/m² and is impregnated with a thermoplastic resin.

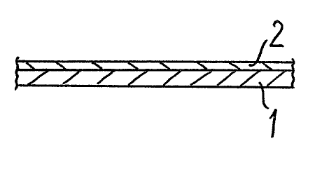

The present invention concerns a textile adhesive tape consisting of an adhesive tape support from a textile, mechanically strengthened nonwoven material and at least one-sided glue coating.

Textile adhesive tapes of the type just mentioned are already known in which the mechanically strengthened nonwoven support consists of a stitched nonwoven. Adhesive tapes are also known in which the mechanical reinforcement of the nonwoven support occurs by water jet or air jet strengthening.

These known adhesive tapes have the common shortcoming that they possess a relatively high basis weight greater than 60 g/m² in order for a sufficient tear strength to be achieved. High material costs result from the relatively high basis weight.

The underlying task of the present invention is to produce a textile adhesive tape that has the same mechanical properties as the known adhesive tapes, especially adequate tear strength with reduced material costs relative to known textile adhesive tapes.

This is achieved according to the invention in that the nonwoven material has a basis weight less than or equal to 60 g/m² and is impregnated with a thermoplastic resin. Cohesion of the nonwoven fibers is achieved by this resin impregnation according to the invention. The tangibly low degree of strengthening from mechanical reinforcement at low basis weight is compensated by this resin impregnation. Depending on the concentration of resin impregnation, nonwovens with high tensile strength or with lower tensile strength can be produced. The resin impregnation preferably has a basis weight of 1 to 5 g/m². For mechanical reinforcement needling in a needle bed can be prescribed, but reinforcement by the water jet and/or air jet technique can also be conducted. Natural rubber adhesives, synthetic rubber adhesives, acrylate adhesives or UV-crosslinked acrylate adhesives can be used as adhesive coating. Resin impregnation has the additional task of increasing the chemical resistance of a nonwoven.

Advantageous variants of the textile adhesive tape according to the invention are contained in the subclaims.

A practical example of an adhesive tape according to the invention is shown in the accompanying drawing.

According to this drawing, a textile adhesive tape according to the invention consists of a textile adhesive tape support 1, on which an adhesive coating 2 is applied on one side. The textile adhesive tape support 1 consists of a textile, mechanically reinforced nonwoven material. This nonwoven material is especially a fiber nonwoven needled in a needle bed. By vertical entry of a number of needles provided with barbs arranged in a needle bed, the fabric formed from individual relatively short fibers is strengthened. Natural fibers, especially viscose fibers, polyester or propylene fibers can be used as fiber material. A fiber blend of at least two of the aforementioned fiber materials also lies within the scope of the invention. The nonwoven material used according to the invention has a basis weight less than or equal to 60 g/m². At such basis weights, a sufficiently high degree of reinforcement cannot be achieved by mechanical reinforcement in order for the finished adhesive tape to have sufficient tear strength. Moreover, the hazard of hole formation is higher, the lower the basis weight. It is now prescribed according to the invention that the mechanically strengthened nonwoven material be impregnated with a thermoplastic resin. Such impregnation can occur in a dipping or spray method. The impregnation preferably has a basis weight from 1 to 5 g/m². Thermoplastic resins are considered as impregnation materials, especially acrylate resins or polyurethane resins. Depending on the resin concentration provided according to the invention, mechanically reinforced adhesive tape supports with higher tensile strength or lower tensile strength can be produced.

The applied adhesive costing advantageously consists of a natural rubber adhesive, a synthetic rubber adhesive, acrylate adhesive or UV-crosslinkable acrylate adhesive.

The automotive industry, handicrafts and the hobby area are proposed as areas of application of the textile adhesive tape according to the invention.

A textile adhesive tape consisting of a resin-impregnated polyethylene nonwoven fiber material with a basis weight of 40 g/m² and an adhesive coating from a synthetic rubber adhesive with a basis weight of 130 g/m² is particularly suited as a winding tape.

If an adhesive tape according to the invention is to be used, for example, as masking tape, use of a polyethylene nonwoven with resin impregnation advantageously offers itself, which has a basis weight of 50 g/m². The adhesive coating then consists of a UV-crosslinked acrylate adhesive with a basis weight of 100 g/m².

The adhesive tape according to the invention is also characterized by good unwinding properties, since the adhesion capacity of the adhesive layer is not adversely affected by resin impregnation but, on the other hand, loosening and tearing out of the nonwoven fibers from the composite during unwinding of the adhesive tape is prevented.

Moreover, resin impregnation prevents bleed-through, i.e., penetration of the adhesive coating through the textile support material.

The textile adhesive tape material according to the invention is characterized by low material costs, since the cost fraction of the textile nonwoven material is decisive in the total cost and a decided cost advantage is achieved by the low basis weight of the textile material according to the invention.

The present invention is not limited to the described practical example. Additional finishing of the adhesive tape according to the invention, for example, with a flame retardant, can also be prescribed.

1. Textile adhesive tape consisting of an adhesive tape support (1), a textile, mechanically reinforced nonwoven material with adhesive coating (2) at least on one side, characterized by the fact that the nonwoven material has a basis weight less than or equal to 60 g/m² and is impregnated with a thermoplastic resin.

2. Adhesive tape according to claim 1, characterized by the fact that the nonwoven material is reinforced by needling in a needle bed.

3. Adhesive tape according to claim 1, characterized by the fact that the nonwoven material is reinforced by air and/or water jets.

4. Adhesive tape according to one of the claims 1 to 3, characterized by the fact that the basis weight of the impregnation is about 1 to 5 g/m².

5. Adhesive tape according to one of the claims 1 to 3, characterized by the fact that the nonwoven material consists of viscose fibers, polyester fibers or propylene fibers or from a fiber blend of at least two of the aforementioned fiber materials.

6. Adhesive tape according to one of the claims 1 to 5, characterized by the fact that the adhesive coating (2) uses a natural rubber adhesive, a synthetic rubber adhesive, an acrylate adhesive or a UV-crosslinkable acrylate adhesive.

7. Adhesive tape according to one of the claims 1 to 6, characterized by the fact that the basis weight of the adhesive coating (2) is about 90 to 150 g/m², especially 100 g/m² to 130 g/m².

8. Adhesive tape according to one of the claims 1 to 7, characterized by the fact that a PET nonwoven having a basis weight of 40 g/m² is used as textile nonwoven material and the adhesive coating consists of a synthetic rubber adhesive with a basis weight of 130 g/m².

9. Adhesive tape according to one of the claims 1 to 7, characterized by the fact that the textile nonwoven consists of a PET nonwoven and has a basis weight of 50 g/m² and the adhesive coating consists of a UV-crosslinkable acrylate adhesive with a basis weight of 150 g/m².
